(19) United States
(12) Patent Application Publication
(10) Pub. No.: US 2011/0261205 A1
(43) Pub. Date: Oct. 27, 2011

(54) METHOD FOR COORDINATING CAMERA ARRAY

(75) Inventor: YU-HUNG SUN, Tu-Cheng (TW)

(73) Assignee: HON HAI PRECISION INDUSTRY CO., LTD., Tu-Cheng,Taipei Hsien (TW)

(21) Appl. No.: 12/860,915

(22) Filed: Aug. 22, 2010

(30) Foreign Application Priority Data
Apr. 23, 2010 (TW) 99112881

(51) Int. Cl. H04N 7/18; H04N 5/232

(52) U.S. Cl. 348/159; 348/211.11; 348/E05.042; 348/E07.085

(57) ABSTRACT

A method for coordinating a camera array that includes a first camera and a second camera to monitor an object. The first camera stores a parameter related to the object. The first camera identifies an image characteristic in an image of the object based on the parameter when capturing the image of the object. The first camera then determines whether the image characteristic is identified in the image. If the image characteristic is identified in the image, the first camera instructs the second camera to capture an enlargement of the image characteristic.

### BACKGROUND

1. Technical Field

The present disclosure relates to a method for coordinating a camera array to monitor an object.

2. Description of Related Art

Cameras/camcorders can be used to monitor an area for security. The cameras/camcorders are disposed at different angles and function individually. However, the cameras/camcorders cannot work in coordination with each other to capture a clear multi-angle image of a specific object. The specific object may be a person face, or a license plate of a vehicle, for example.

### BRIEF DESCRIPTION OF THE DRAWINGS

FIG. 1 is a block diagram of one embodiment of a camera array.

FIG. 2 is a block diagram of a monitor system of FIG. 1.

FIG. 3 is a flowchart illustrating one embodiment of a method for coordinating a camera array.

### DETAILED DESCRIPTION

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

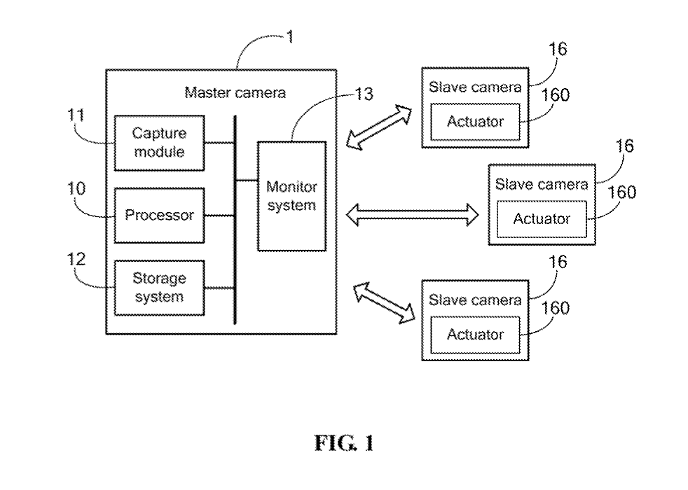

FIG. 1 is a block diagram of one embodiment of a camera array. The camera array includes a first camera and a second camera operable to monitor an object (not shown). In the embodiment, the first camera is a master camera 1 and the second camera is a slave camera 16. The master camera 1 and the slave camera 16 may be cameras, video cameras, or camcorders, for example. The master camera 1 includes a processor 10, a capture module 11, a storage system 12, and a monitor system 13. The processor 10 may execute one or more programs stored in the storage system 12 to provide functions for the capture module 11 and the monitor system 13. The storage system 12 further stores a parameter related to the object. The parameter may be set by a user. The parameter includes a person or a vehicle, for example. If the person is the object desired to the user, the user may set the parameter as the person.

The master camera 1 is generally controlled and coordinated by an operating system, such as UNIX, Linux, Windows, Mac OS, an embedded operating system, or any other compatible system. Alternatively, the master camera 1 may be controlled by a proprietary operating system. Typical operating systems control and schedule computer processes for execution, perform memory management, provide file system, networking, and I/O services, and provide a user interface, such as a graphical user interface (GUI), among other tasks.

The capture module 11 is operable to capture an image of the object and may include a lens, a zoom mechanism, a camera shutter, and a charge-coupled device (CCD) sensor/complementary metal-oxide-semiconductor (CMOS) sensor. The capture module 11 further includes a setting interface (not shown) for the user to set the parameter. The master camera 1 electronically connects with at least one slave camera 16 and controls the slave camera 16 through the monitor system 13. In the embodiment, the master camera 1 electronically connects with three slave cameras 16. The slave camera 16 includes an actuator 160 operable to rotate the slave camera 16 about a pivot point. The actuator 160 may be a servomotor.

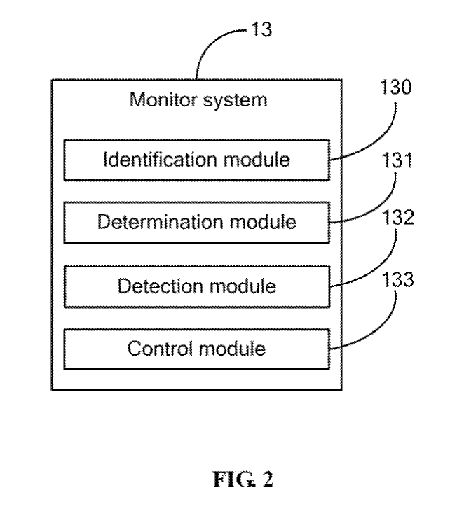

FIG. 2 is a block diagram of the monitor system 13 of FIG. 1. The monitor system 13 includes an identification module 130, a determination module 131, a detection module 132, and a control module 133. The identification module 130 is operable to identify an image characteristic in the image of the object based on the parameter. The image characteristic may include a person's face, or a license plate of a vehicle, for example. When the capture module 11 captures the image of the object, the identification module 130 identifies whether the image conforms to the parameter. In the embodiment, the parameter is set as the person and therefore the image characteristic is the person's face. The identification module 130 identifies the person's face with the formula of face color as:

$${Skin}_{color} ( x , y ) = \{ \begin{matrix}1 , & if [ Cr ( x , y ) ∈ {Skin}_{Cr} ] ⋂ [ Cb ( x , y ) ∈ {Skin}_{Cb} ] \\ 0 , & otherwise\end{matrix}$$

if the image conforms to the person.

The determination module 131 is operable to determine whether the image characteristic is identified in the object. The detection module 132 is operable to calculate a coordinate of the image characteristic corresponding to the master camera 1 and calculate a distance between the image characteristic and the master camera 1. The detection module 132 may be a sonar system or a proximity sensor, for example. The determination module 131 further determines a multiple of a focal length of the slave camera 16 based on the distance. The multiple of the focal length of the slave camera 16 means a zoom multiple of the slave camera 16. The control module 133 connects with the slave camera 16. The control module 133 instruct the slave camera 16 to aim at the image characteristic based on the coordinate and capture an enlargement of the image characteristic based on the multiple of the focal length. Particularly, the control module 133 instructs the slave camera 16 to execute a zoom-in operation to capture the enlargement of the image characteristic.

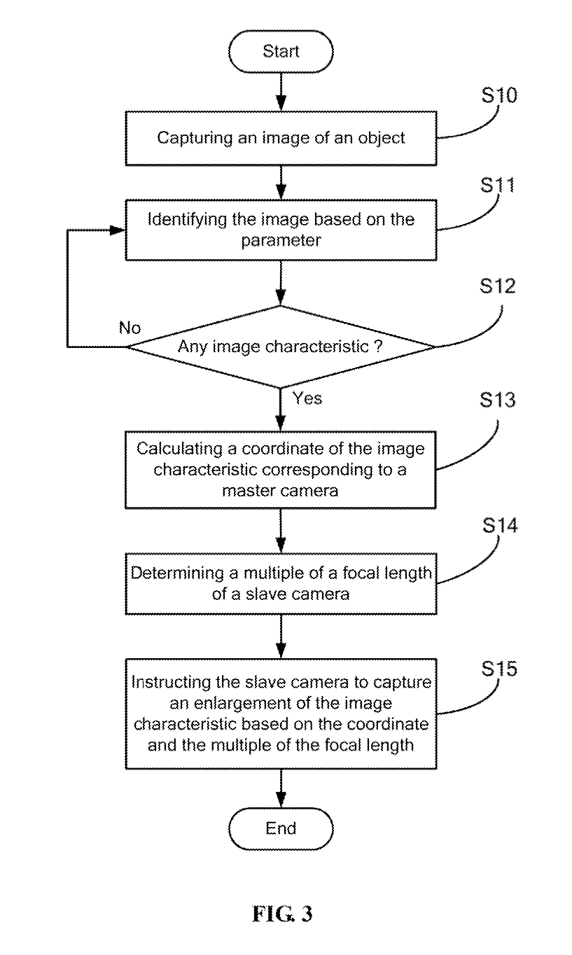

FIG. 3 is a flowchart illustrating a method for coordinating the camera array to monitor the object. Depending on the embodiment, additional blocks in the flow of FIG. 3 may be added, others removed, and the ordering of the blocks may be changed.

In block S10, the capture module 11 captures the image of the object.

In block S11, the identification module 130 identifies the image characteristic in the image based on the parameter when the capture module 11 captures the image of the object.

In block S12, the determination module 131 determines whether the image characteristic identified in the object. If no image characteristic is identified in the object, block S11 is repeated.

If the image characteristic is identified in the object, in block S13, the detection module 132 calculates the coordinate of the image characteristic corresponding to the master camera 1.

In block S14, the detection module 132 calculates the distance between the image characteristic and the master camera 1, and further calculates the multiple of the focal length of the slave camera 16 based on the distance.

In block S15, the control module 133 instructs the slave camera 16 to aim at the image characteristic based on the coordinate and capture the enlargement of the image characteristic based on the multiple of the focal length.

The present disclosure provides a method for coordinating a camera array to monitor an object. As a result, an image characteristic of the object may be clearly captured.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for coordinating a first camera and a second camera to monitor an object, the first camera storing a parameter related to the object and being in communication with the second camera, the method comprising:
identifying an image characteristic in the object based on the parameter;
determining whether the image characteristic is identified in the object; and
instructing the second camera to capture an enlargement of the image characteristic when the image characteristic is identified in the object.

2. The method of claim 1, further comprising:
calculating a coordinate of the image characteristic corresponding to the first camera.

3. The method of claim 2, further comprising:
calculating a distance between the image characteristic and the first camera.

4. The method of claim 3, further comprising:
determining a multiple of a focal length of the second camera based on the distance.

5. The method of claim 4, the step of instructing the second camera further comprises:
instructing the second camera to aim at the image characteristic based on the coordinate and capture the enlargement of the image characteristic based on the multiple of the focal length.

6. A camera capable of connecting with a slave camera, comprising:
a storage system;
at least one processor;
one or more programs stored in the storage system and be executable by the at least one processor;
a parameter related to an object stored in the storage system;
an identification module operable to identify an image characteristic in the object based on the parameter;
a determination module operable to determine whether the image characteristic is identified in the object; and
a control module operable to instruct the slave camera to capture an enlargement of the image characteristic.

7. The camera of claim 6, further comprises a detection module operable to:
calculate a coordinate of the image characteristic corresponding to the camera; and
calculate a distance between the image characteristic and the camera.

8. The camera of claim 7, wherein the determination module further determines a multiple of a focal length of the slave camera based on the distance.

9. The camera of claim 8, wherein the control module further instructs the slave camera to aim at the image characteristic based on the coordinate and capture the enlargement of the image characteristic based on the multiple of the focal length.

10. A storage medium having stored thereon instructions that, when executed by a processor, causing the processor to perform a method for coordinating a first camera and a second camera to monitor an object, the first camera stores a parameter related to the object and is in communication with the second camera, wherein the method comprises:
identify an image characteristic in the object based on the parameter;
determine whether the image characteristic is identified in the object; and
instruct the second camera to capture an enlargement of the image characteristic when the image characteristic is identified in the object.

11. The storage medium of claim 10, wherein the method further comprises:
calculate a coordinate of the image characteristic corresponding to the first camera.

12. The storage medium of claim 11, wherein the method further comprises:
calculate a distance between the image characteristic and the first camera.

13. The storage medium of claim 12, wherein the method further comprises:
determine a multiple of a focal length of the second camera based on the distance.

14. The storage medium of claim 13, wherein the method further comprises:
instruct the second camera to aim at the image characteristic based on the coordinate and capture the enlargement of the image characteristic based on the multiple of the focal length.
